(19) United States
(12) Patent Application Publication
(10) Pub. No.: US 2013/0344378 A1
(43) Pub. Date: Dec. 26, 2013

(54) ASSEMBLED BATTERY AND CELL CONNECTION METHOD

(71) Applicants: Yasuhiro Kohara, Suita City (JP); Mayumi Nakasato, Ogaki City (JP); Fusanori Watanabe, Ogaki City (JP); Yasuhiro Asai, Kasai City (JP); Takashi Seto, Kakogawa City (JP); Daiki Uchiyama, Kasai City (JP)

(72) Inventors: Yasuhiro Kohara, Suita City (JP); Mayumi Nakasato, Ogaki City (JP); Fusanori Watanabe, Ogaki City (JP); Yasuhiro Asai, Kasai City (JP); Takashi Seto, Kakogawa City (JP); Daiki Uchiyama, Kasai City (JP)

(73) Assignee: SANYO ELECTRIC CO., LTD., Moriguchi City, Osaka (JP)

(21) Appl. No.: 14/001,933

(22) PCT Filed: Feb. 3, 2012
(86) PCT No.: PCT/JP2012/000729

§ 371 Date: Aug. 28, 2013

(30) Foreign Application Priority Data
Mar. 10, 2011 (JP) 2011053616

(51) Int. Cl. H01M 2/24

(52) U.S. Cl. CPC H01M 2/24
USPC 429/158; 29/825

(57) ABSTRACT

An assembled battery comprises: multiple cells 30 each having external terminals including a negative electrode terminal 50 and a positive electrode terminal 60; a bus bar 40 configured to connect the external terminal of one of two adjacent cells 30 to the external terminal of the other of these two adjacent cells 30; a connecting member 70 welded to the external terminal and the bus bar 40 so as to electrically connect the external terminal and the bus bar 40; a welding portion 80 at which the external terminal and the connecting member 70 are welded; and a welding portion 82 at which the bus bar 40 and the connecting member 70 are welded. The external terminal has a region that is at a distance from an outer package as compared with a portion of the connecting member 70 that is adjacent to the welding portion 80.

### TECHNICAL FIELD

The present invention relates to an assembled battery and a cell connection method.

### BACKGROUND ART

With a typical assembled battery configured by connecting multiple cells in series, adjacent cells are connected in series such that the positive electrode terminal of one of two adjacent cells is connected to the negative electrode terminal of the other of these cells by means of a bus bar. As a connection mechanism that connects the bus bar and the external terminals including the positive electrode terminal and the negative electrode terminal, a connection mechanism is known in which the external terminal is inserted into an opening formed in the bus bar, and a fixation screw is screwed into the end of the external terminal, thereby connecting the external terminal and the bus bar (see Patent document 1).

### RELATED ART DOCUMENTS

### Patent Documents

### [Patent Document 1]

Japanese Patent Application Laid Open No. 2004-253311

### DISCLOSURE OF THE INVENTION

### Problem to be Solved by the Invention

In a case in which the external terminal and the bus bar are fixedly connected via a screw in the same way as with the aforementioned conventional mechanism, in some cases, such a fixation screw loosens after being screwed in. Thus, there is room for further improvement from the viewpoint of improved reliability of the connection between the external terminal and the bus bar. In order to provide such improved reliability of the connection, an arrangement is conceivable in which a portion of a connecting member is welded to the external terminal, and a different portion of the connecting member is welded to the bus bar, thereby connecting the external terminal and the bus bar via the connecting member.

The present inventors have diligently studied the mechanism for connecting the aforementioned external terminal and the bus bar via a connecting member by welding, and have found the following problem. That is to say, with such an arrangement, if a difference occurs between their levels, the tip portion of the external terminal and the connecting member or the like are welded with insufficient strength. In some cases, this leads to an increase in the resistance of the welding portion, and degradation of the connection strength.

The present invention has been made in order to solve such a problem. Accordingly, it is a general purpose of the present invention to provide a technique for providing welding with sufficient connection strength in a sure manner to the connection between an external terminal of a cell and an electrical connection member (bus bar), thereby suppressing an increase in the resistance of the welding portion and degradation of the connection strength.

### Means to Solve the Problem

An embodiment of the present invention relates to an assembled battery. The assembled battery comprises: multiple cells each comprising an electrode body, a casing configured to house the electrode body, and external terminals each of which is configured as an exterior component of the casing and each of which is electrically connected to the electrode body; an electrical connection member configured to have a through hole which allows the external terminal to pass through it, and to electrically connect the external terminal of one of two adjacent cells and the external terminal of the other of these two adjacent cells; an electrically conductive connecting member configured to fixedly connect a terminal connection portion of the external terminal, which is a tip region passing through the through hole, and the electrical connection member arranged so as to surround the terminal connection portion; and a welding portion configured to connect the terminal connection portion and the connecting member. The terminal connection portion has a region that is at a distance from the casing as compared with a portion of the connecting member that is adjacent to the welding portion.

With the assembled battery according to the aforementioned embodiment, the connecting member may be configured such that, in the vicinity of the welding portion, its thickness becomes greater as the distance increases from the welding portion.

Another embodiment of the present invention also relates to an assembled battery. The assembled battery comprises: multiple cells each comprising an electrode body, a casing configured to house the electrode body, and external terminals each of which is configured as an exterior component of the casing and each of which is electrically connected to the electrode body; an electrical connection member configured to have a through hole which allows the external terminal to pass through it, and to electrically connect the external terminal of one of two adjacent cells and the external terminal of the other of these two adjacent cells; and a welding portion configured to connect a terminal connection portion of the external terminal, which is a tip region passing through the through hole, and the electrical connection member arranged so as to surround the terminal connection portion. The terminal connection portion has a region that is at a distance from the casing as compared with a portion of the electrical connection member that is adjacent to the welding portion.

With the assembled battery according to the aforementioned embodiment, the electrical connection member may be configured such that, in the vicinity of the welding portion, its thickness becomes greater as the distance increases from the welding portion.

Yet another embodiment of the present invention relates to a cell connection method. The cell connection method is configured as a method for connecting an external terminal of a cell to an electrical connection member configured to electrically connect the external terminal of one of two adjacent cells and the external terminal of the other of these two adjacent cells. The cell connection method comprises: preparing an electrical connection member having a through hole which allows the external terminal to pass through it; inserting a tip portion of the external terminal into the through hole such that the tip portion passes through the through hole; arranging an electrically conductive connecting member such that it is in contact with a face of the electrical connection member in a region a predetermined distance below an upper end of the tip portion on a side that is opposite to the cell; and welding a contact portion at which the tip portion and the connecting member are in contact.

With the cell connection method according to the aforementioned embodiment, the connecting member may be configured such that, in the vicinity of the contact portion at which the electrical connection member and the tip portion are in contact, its thickness becomes greater as the distance increases from the contact portion.

Yet another embodiment of the present invention also relates to a cell connection method. The cell connection method is configured as a method for connecting an external terminal of a cell to an electrical connection member configured to electrically connect the external terminal of one of two adjacent cells and the external terminal of the other of these two adjacent cells. The cell connection method comprises: preparing an electrical connection member having a through hole which allows the external terminal to pass through it; inserting a tip portion of the external terminal into the through hole such that the tip portion passes through the through hole; arranging the electrical connection member such that it is in contact with a region a predetermined distance below an upper end of the tip portion; and welding a contact portion at which the tip portion is in contact with the electrical connection member.

With the cell connection method according to the aforementioned embodiment, the electrical connection member may be configured such that, in the vicinity of the contact portion at which the electrical connection member and the tip portion are in contact, its thickness becomes greater as the distance increases from the welding portion.

### Advantage of the Present Invention

In a case in which welding is used to connect an external terminal of a cell and an electrical connection member (bus bar), such an arrangement according to the present invention provides welding with sufficient connection strength in a sure manner.

### BRIEF DESCRIPTION OF THE DRAWINGS

FIG. 1 is a perspective view showing a schematic configuration of an assembled battery according to an embodiment 1;

FIG. 2 is a cross-sectional diagram showing a schematic configuration of a cell;

FIG. 3 is an enlarged perspective view showing a schematic configuration in the vicinity of a connection portion at which an external terminal of the cell and a bus bar are connected;

FIG. 4 is a cross-sectional diagram taken along the line A-A in FIG. 3;

FIG. 5A is a perspective view showing a schematic configuration of a connecting member, and FIG. 5B is a cross-sectional diagram taken along the line B-B in FIG. 5A;

FIGS. 6A through 6C are cross-sectional process diagrams each showing a cell connection method according to the embodiment 1;

FIGS. 7A through 7C are enlarged cross-sectional diagrams respectively showing the schematic configurations of assembled batteries according to modifications 1 through 3, before welding in the vicinity of a connection portion at which the external terminal and the bus bar are connected;

FIG. 8 is an enlarged cross-sectional diagram showing a schematic configuration of an assembled battery according to an embodiment 2 in the vicinity of a connection portion at which an external terminal and a bus bar are connected; and

FIGS. 9A through 9C are cross-sectional process diagrams each showing a cell connection method according to the embodiment 2.

### BEST MODE FOR CARRYING OUT THE INVENTION

Description will be made regarding an embodiment of the present invention with reference to the drawings. It should be noted that, in all the drawings, the same components are denoted by the same reference symbols, and description thereof will be omitted as appropriate.

### Embodiment 1

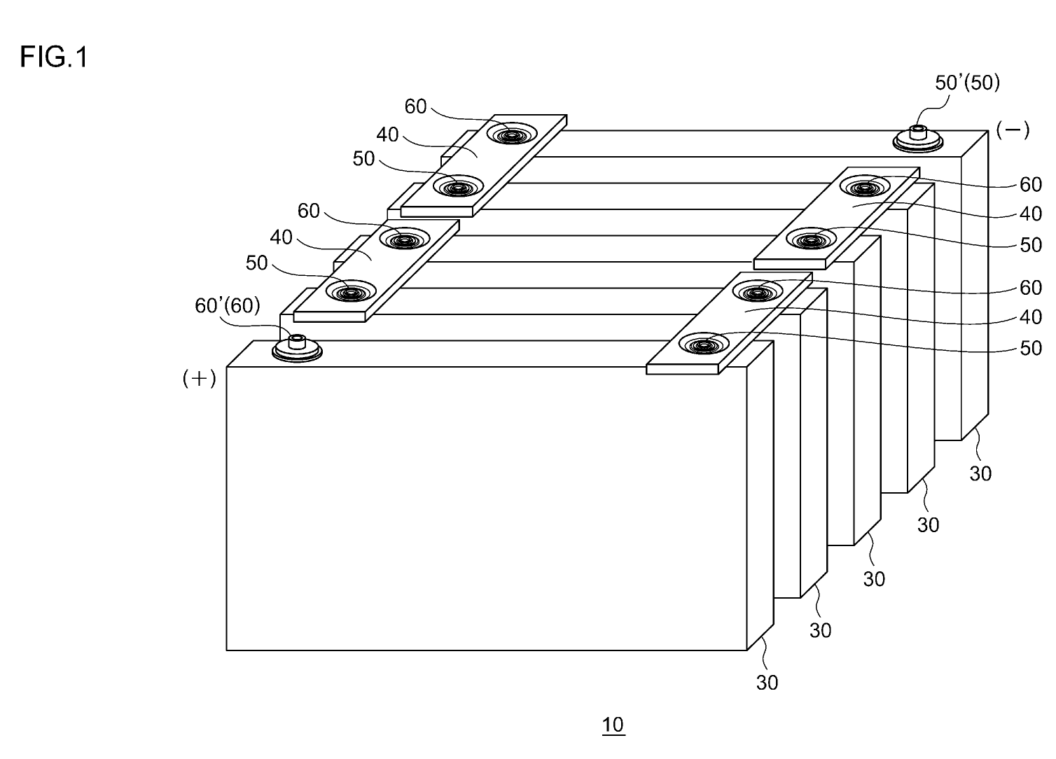

FIG. 1 is a perspective view showing a schematic configuration of an assembled battery according to an embodiment 1. As shown in FIG. 1, an assembled battery 10 includes multiple cells 30 and bus bars 40 (electrical connection members) configured to connect the cells 30. Description will be made in the present embodiment regarding an arrangement in which a total of five cells 30 are connected in series so as to form the assembled battery 10. It should be noted that the number of cells 30 is not restricted in particular. FIG. 1 shows an arrangement in which all of the five cells 30 are connected in series. Also, a part of the cells 30 may be connected in parallel.

The five cells 30 each include a flat, box-shaped casing, and are arranged in parallel at predetermined intervals such that their main faces are arranged approximately in parallel and such that the main faces of adjacent cells face each other. On the top face of the casing of each cell 30, a negative electrode terminal 50 is provided such that it is arranged close to one side of the top face along the longitudinal direction, and a positive electrode terminal 60 is provided such that it is arranged close to the other side of the top face. The negative electrode terminal 50 and the positive electrode terminal 60 will be collectively referred to as the “external terminals” hereafter. The cells 30 are arranged such that the arrangement of the positive electrode 50 and the negative electrode 60 of each cell is opposite to that of the adjacent cell 30. Each pair of adjacent cells 30 are arranged such that the positive electrode terminal 60 of one cell 30 is connected to the negative electrode terminal 50 of the other cell 30 by means of the bus bar 40, thereby connecting the five cells 30 in series.

The cells 30 are housed in a housing (not shown). Such an arrangement allows the positive electrode terminal 60′, which is one terminal of the series connection of the cells 30, and the negative electrode terminal 50′, which is the other of its terminals, to be connected to an external load (not shown) via external wiring (not shown).

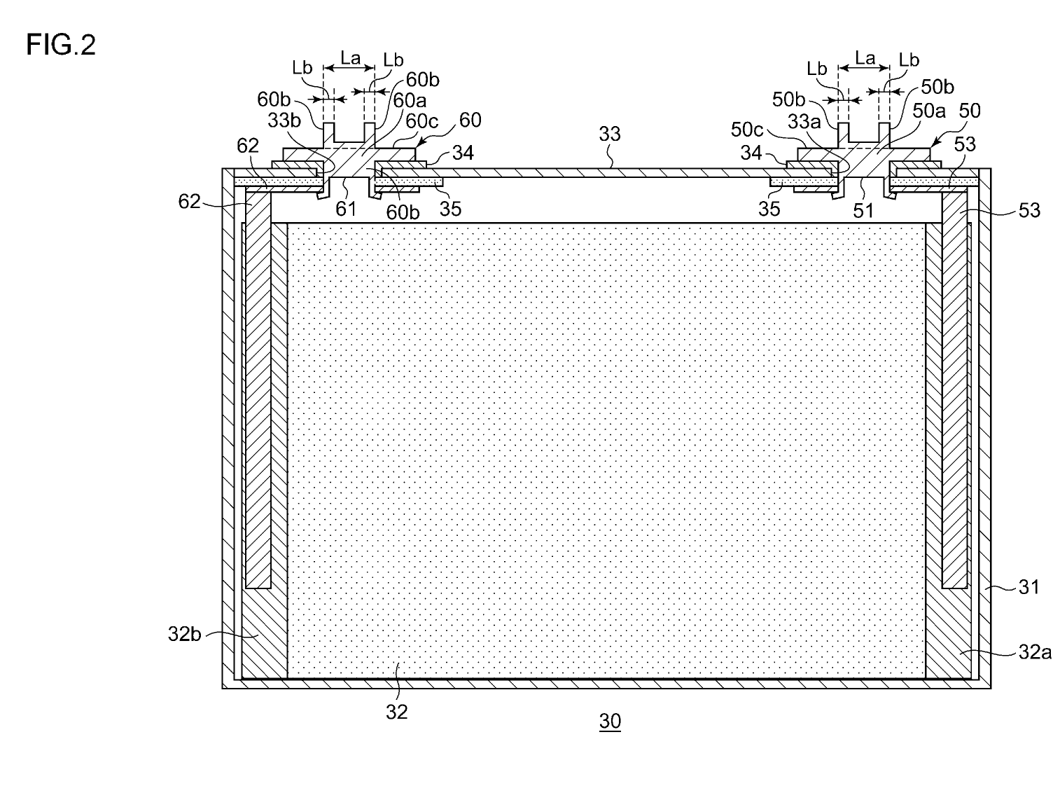

FIG. 2 is a cross-sectional view showing a schematic configuration of the cell. As shown in FIG. 2, the cell 30 has a configuration in which a wound electrode body 32 having a positive electrode and a negative electrode which are wound in a spiral is housed in an outer package (casing) 31 laterally with respect to the package axis of the outer package 31. The opening of the outer package 31 is sealed by means of a sealing plate 33 configured as a component of the casing. The negative electrode terminal 50 and the positive electrode terminal 60 are provided to the sealing plate 33. Furthermore, a gas discharge valve (not shown) is formed in the sealing plate 33.

The negative electrode terminal 50 has a base portion 50a and a terminal connection portion 50b protruding from the base portion 50a. The terminal connection portion 50b represents a tip region of the negative electrode terminal 50 to be arranged such that it passes through a through hole 41 formed in the bus bar 40 described later. With the present embodiment, a recess is formed in the terminal connection portion 50b such that an opening is formed in the tip portion side of the terminal connection portion 50b. With such an arrangement, a part of the terminal connection portion 50b has a hollow cylindrical shape. The base portion 50a is formed in approximately a cylindrical shape, and includes a flange portion 50c around its outer edge. The base portion 50a of the negative electrode terminal 50 is inserted into the negative electrode opening 33a formed in the sealing plate 33 in a state in which the gasket 34 is in contact with the side face of the base portion 50a. Furthermore, the gasket 34 is arranged such that it is in contact with the face of the flange portion 50c that faces the sealing plate 33. Moreover, the base portion 50a is connected to a negative electrode tab member 53 on the inner side of the cell with the sealing plate 33 as a boundary.

At the end of the base portion 50a on the outer side of the cell, the terminal connection portion 50b having an approximately cylindrical shape is monolithically formed with the base portion 50a such that it protrudes upward. At the other end of the base portion 50a on the inner side of the cell, a recess 51 is provided so as to define the side wall along the negative electrode opening 33a. By swaging the edge of the recess 51 such that it expands outward, such an arrangement allows the negative electrode terminal 50 to be fixedly mounted on the negative electrode tab member 53.

An insulating plate 35 is provided between the negative electrode tab member 53 and the side face of the sealing plate 33 on the inner side of the cell. The insulating plate 35 is arranged such that it is in contact with the gasket 34 in the negative electrode opening 33a. Such an arrangement insulates the negative electrode tab member 53 and the negative electrode terminal 50 from the sealing plate 33. The negative electrode tab member 53 is connected to a negative electrode collecting plate set 32a protruding from one end of the electrode body 32. It should be noted that the negative electrode collecting plate set 32a is configured as a bundle of multiple negative electrode collecting plates protruding from one end of the electrode body 32.

The positive electrode terminal 60 includes a base portion 60a and a terminal connection portion 60b protruding from the base portion 60a. The terminal connection portion 60b represents a tip region of the positive electrode terminal 60 to be arranged such that it passes through a through hole 41 formed in the bus bar 40 described later. With the present embodiment, a recess is formed in the terminal connection portion 60b such that an opening is formed in the tip portion side of the terminal connection portion 60b. With such an arrangement, a part of the terminal connection portion 60b has a hollow cylindrical shape. The base portion 60a is formed in approximately a cylindrical shape, and includes a flange portion 60c around its outer edge. The base portion 60a of the positive electrode terminal 60 is inserted into the positive electrode opening 33b formed in the sealing plate 33 in a state in which the gasket 34 is in contact with the side face of the base portion 60a. Furthermore, the gasket 34 is arranged such that it is in contact with the face of the flange portion 60c that faces the sealing plate 33. Moreover, the base portion 60a is connected to a positive electrode tab member 62 on the inner side of the cell with the sealing plate 33 as a boundary.

At the end of the base portion 60a on the outer side of the cell, the terminal connection portion 60b having an approximately cylindrical shape is monolithically formed with the base portion 60a such that it protrudes upward. At the other end of the base portion 60a on the inner side of the cell, a recess 61 is provided so as to define the side wall along the positive electrode opening 33b. By swaging the edge of the recess 61 such that it expands outward, such an arrangement allows the positive electrode terminal 60 to be fixedly mounted on the positive electrode tab member 62.

An insulating plate 35 is provided between the positive electrode tab member 62 and the side face of the sealing plate 33 on the inner side of the cell. The insulating plate 35 is arranged such that it is in contact with the gasket 34 in the positive electrode opening 33b. Such an arrangement insulates the positive electrode tab member 62 and the positive electrode terminal 60 from the sealing plate 33. The positive electrode tab member 62 is connected to a positive electrode collecting plate set 32b protruding from the other end of the electrode body 32. It should be noted that the positive electrode collecting plate set 32b is configured as a bundle of multiple positive electrode collecting plates protruding from the other end of the electrode body 32.

Description has been made in the present embodiment regarding an arrangement in which the main body portions 50a and 60a are each configured to have an approximately cylindrical shape. Also, the main body portions 50a and 60a may each be configured to have a hollow circular pipe shape obtained by eliminating, from the aforementioned main body portion having an approximately cylindrical shape, a core portion along the axis. In this case, this circular pipe is configured to have a thickness that is greater than that of the terminal connection portion 50b or that of the terminal connection portion 60b.

With the present embodiment, a part of the terminal connection portion 50b and a part of the terminal connection portion 60b are each configured to have a hollow cylindrical shape. Also, such a terminal connection portion may be configured to have a cylindrical shape that does not have such a recess as described above. Also, such a terminal connection portion may be configured to have a hollow cylindrical shape over the entire region.

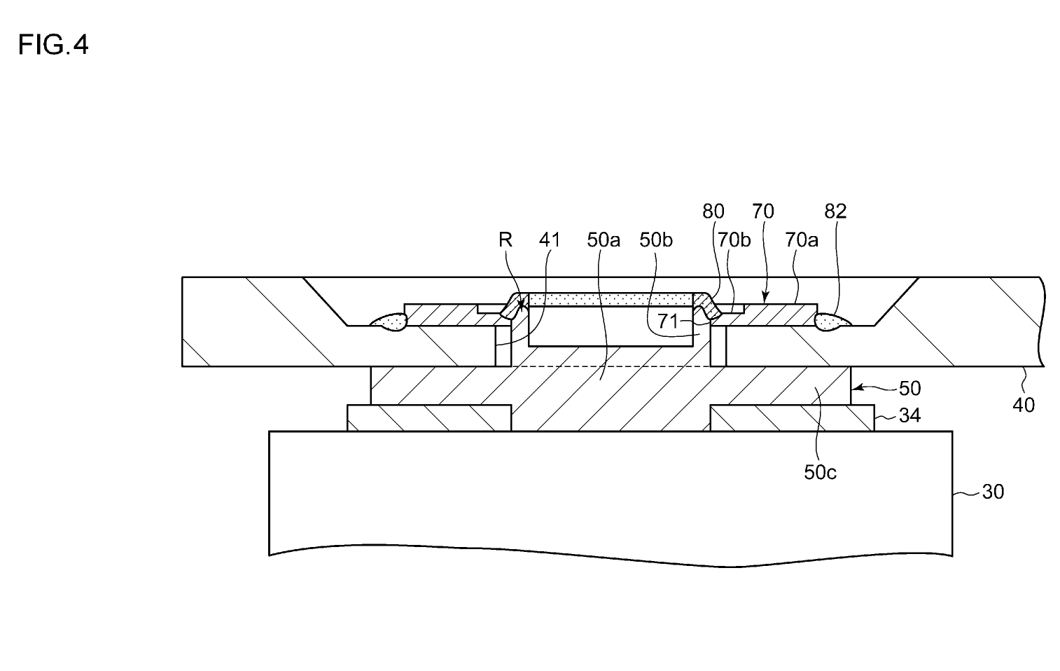

Each bus bar 40 is configured as a band-shaped member formed of an electrically conductive material such as metal or the like. Through holes 41 (see FIG. 4) are formed at both ends of the bus bar 40. The negative electrode terminal 50 of one of two adjacent cells 30 is inserted into one of the through holes 41 formed in the bus bar 40. Furthermore, the positive electrode terminal 60 of the other of these adjacent cells 30 is inserted into the other of the through holes 41.

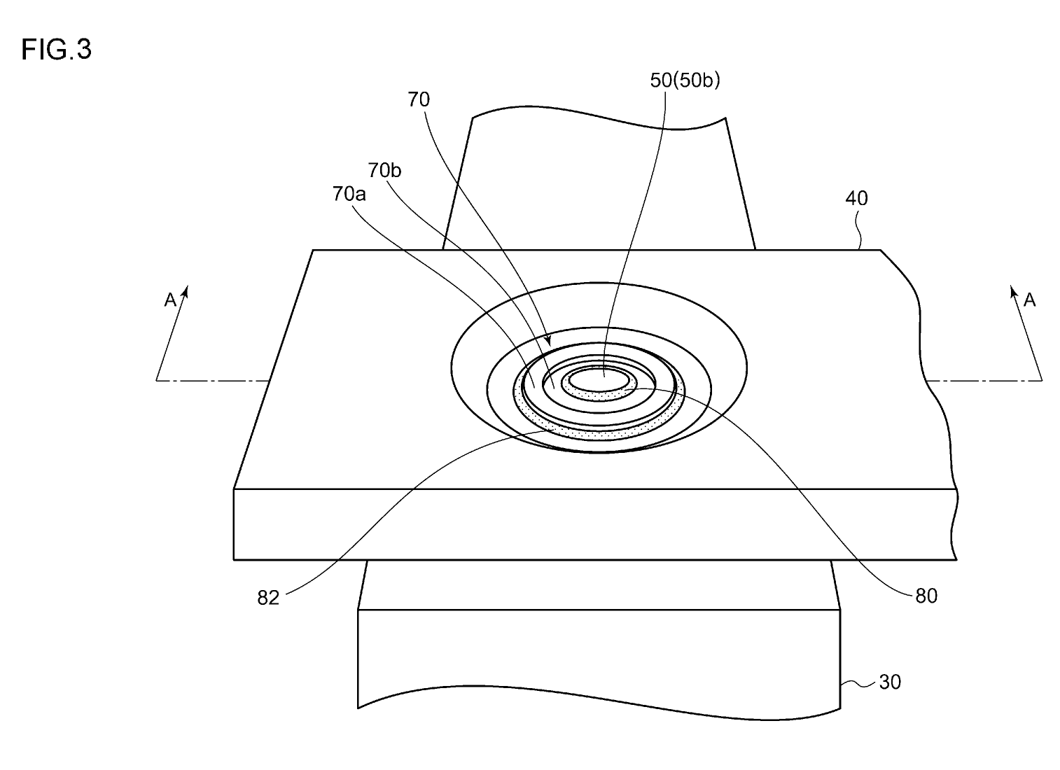

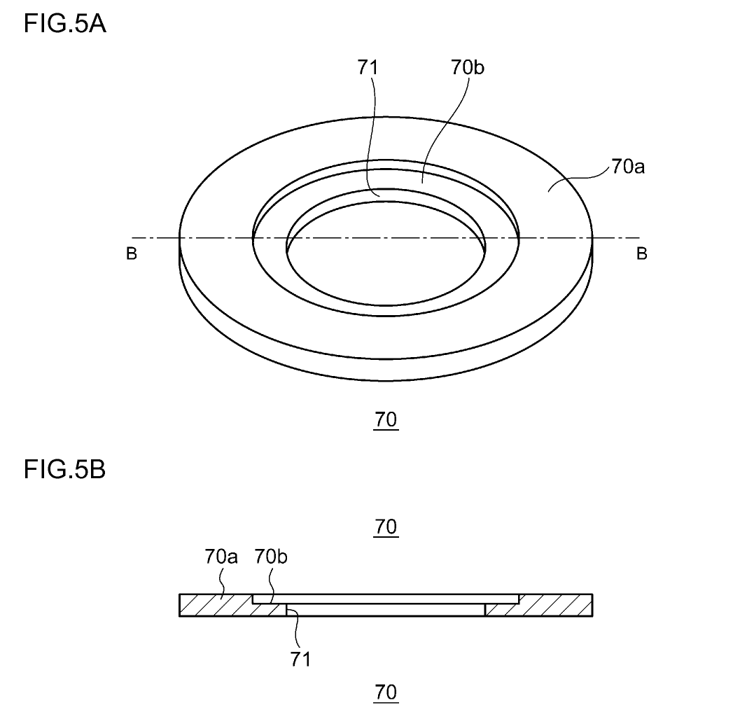

FIG. 3 is an enlarged perspective view showing a schematic configuration in the vicinity of the connection portion that connects the external terminal of the cell and the bus bar. FIG. 4 is a cross-sectional view taken along the line A-A in FIG. 3. FIG. 5A is a perspective view showing a schematic configuration of the connecting member. FIG. 5B is a cross-sectional view taken along the line B-B in FIG. 5A. It should be noted that FIGS. 3 and 4 each show the negative electrode terminal 50 as an example of the external terminal.

As shown in FIGS. 3 and 4, the negative electrode terminal 50 and the bus bar 40 are connected via a connecting member 70. That is to say, a portion of the connecting member 70 is welded to the negative electrode terminal 50, and a different portion of the connecting member 70 is welded to the bus bar 40, thereby connecting the negative electrode terminal 50 and the bus bar 40 to each other.

As shown in FIGS. 5A and 5B, the connecting member 70 is configured as a ring-shaped member formed of an electrically conducive material such as metal or the like, and is configured to have a through hole 71 formed in its central portion. The connecting member 70 comprises a base portion 70a positioned on its outer circumference side, and a connection portion 70b monolithically formed with the base portion 70a such that it is positioned over the edge of the through hole 71. The connection portion 70b is configured to have a thickness that is smaller than that of the base portion 70a and such that it protrudes from the base portion 70a toward the through hole 71 side. The base portion 70a is configured to have a thickness of approximately 0.1 mm to 5 mm, for example; and the connection portion 70b is configured to have a thickness of approximately 0.05 mm to 2.5 mm, for example. Furthermore, the connection portion 70b is configured to have a protrusion length, i.e., a length from its tip portion on the through hole 71 side up to the other end portion connected to the base portion 70a, that is greater than the radius of the laser beam emitted in the welding.

The terminal connection portion 50b of the negative electrode terminal 50 is inserted into the through hole 41 of the bus bar 40 such that a part of its tip portion protrudes from the opening of the through hole 41 on the side that is opposite to the cell 30. The bus bar 40 is arranged such that its lower face is in contact with the upper face of the flange portion 50c of the negative electrode terminal 50. Furthermore, the terminal connection portion 50b is inserted into the through hole 71 of the connecting member 70 arranged on the bus bar 40 such that a part of its tip portion protrudes from the opening of the through hole 71 on the side that is opposite to the cell 30.

With such an arrangement, the tip of the connection portion 70b of the connecting member 70 and the terminal connection portion 50b are connected to each other by means of the welding portion 80. The terminal connection portion 50b has a region (portion indicated by the arrow R in FIG. 4) at a distance from the bottom of the outer package 31 (bottom of the cell 30) as compared with a portion of the connecting member 70 adjacent to the welding portion 80, i.e., the connection portion 70b. In other words, the welding portion 80 is positioned at a predetermined distance below the upper end of the terminal connection portion 50b. Furthermore, the upper face of the connection portion 70b adjacent to the welding portion 80 is positioned below the upper end of the terminal connection portion 50b. As described above, the welding portion 80 is mainly formed by melting the tip portion of the connection portion 70b by means of laser emission. Thus, the tip (one end) of the remaining portion of the connection portion 70b is arranged in contact with the welding portion 80.

Furthermore, the lower portion of the outer circumference face of the base portion 70a and the bus bar 40 are connected to each other by means of the welding portion 82.

### [Cell Connection Method]

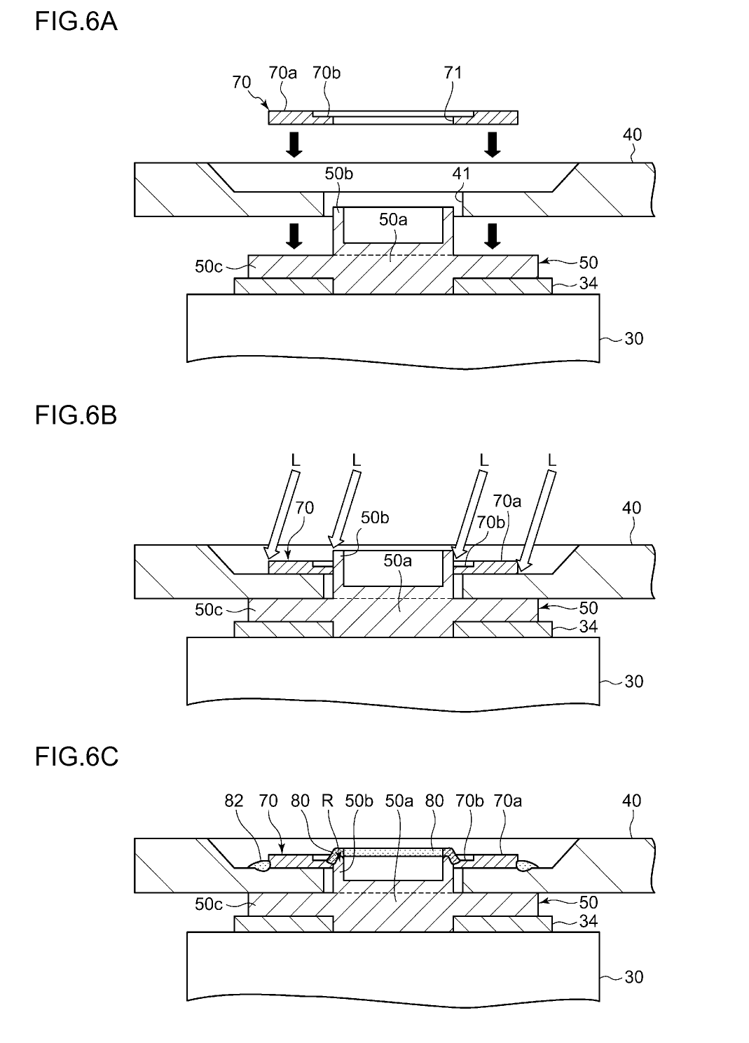

Next, description will be made with reference to FIGS. 6A through 6C regarding a cell connection method for electrically connecting the external terminal of each cell 30 to the bus bar 40. FIGS. 6A through 6C are cross-sectional process diagrams each showing a cell connection method according to the embodiment 1. It should be noted that FIGS. 6A through 6C each show the negative electrode terminal 50 as an example of the external terminal.

First, as shown in FIG. 6A, the cell 30 is prepared, which includes the external terminals each comprising the main base portion 50a and the terminal connection portion 50b having a thickness that is smaller than that of the base portion 50a and protruding from the base portion 50a. Furthermore, the connecting member 70 is prepared, which includes the base portion 70a and the connection portion 70b having a thickness that is smaller than that of the base portion 70a and protruding from the base portion 70a. In addition, the bus bar 40 is prepared, which is configured to have the through hole 41 at a predetermined position. Next, after the negative electrode terminal 50 and the through hole 41 of the bus bar 40 are aligned, the bus bar 40 is mounted on the negative electrode terminal 50 such that the terminal connection portion 50b passes through the through hole 41. Subsequently, after the negative electrode terminal 50 and the through hole 71 of the connecting member 70 are aligned, the connecting member 70 is mounted on the bus bar 40 such that the terminal connection portion 50b passes through the through hole 71.

As shown in FIG. 6B, after the connecting member 70 is mounted on the bus bar 40, the tip portion of the connection portion 70b is arranged in contact with the terminal connection portion 50b in a region a predetermined distance below the upper end of the terminal connection portion 50b. In this state, a laser L is emitted to the tip portion of the connection portion 70b so as to melt the tip portion of the connection portion 70b and a part of the terminal connection portion 50b, thereby welding the connection portion 70b and the terminal connection portion 50b. Furthermore, the laser L is emitted to a position at which the lower portion of the outer circumference face of the base portion 70a is in contact with the bus bar 40, so as to melt a part of the base portion 70a and a part of the upper face of the bus bar 40, thereby welding the base portion 70a and the bus bar 40. The laser L is emitted over the entire circumference of the contact portion where the tip portion of the connection portion 70b is in contact with the terminal connection portion 50b, and is emitted over the entire circumference of the contact portion where the lower portion of the outer circumference face of the base portion 70a is in contact with the bus bar 40. It should be noted that the region to be irradiated by the laser L is not restricted to such a region. Rather, the laser L may be emitted to only a part of such a contact region where the tip portion of the connection portion 70b is in contact with the terminal connection portion 50b, or may be emitted to only a part of such a contact region where the lower portion of the outer circumference face of the base portion 70a is in contact with the bus bar 40, as long as such an arrangement provides sufficient connection strength.

By means of the laser L emission described above, as shown in FIG. 6C, the welding portion 80 is formed between the remaining portion of the connection portion 70b and the terminal connection portion 50b, thereby connecting the connecting member 70 and the terminal connection portion 50b. In this stage, a region R is formed as a remaining portion of the terminal connection portion 50b, which is at a distance from the cell 30 as compared with a portion of the connection portion 70b adjacent to the welding portion 84. Furthermore, the welding portion 82 is formed between the remaining portion of the base portion 70a and the bus bar 40, thereby connecting the connecting member 70 and the bus bar 40. It should be noted that the order of the connection step for connecting the connecting member 70 and the bus bar 40, and the connection step for connecting the connecting member 70 and the negative electrode terminal 50, is not restricted in particular. Also, these connection steps may be executed in parallel.

As described above, with the assembled battery 10 according to the present embodiment, the laser L is emitted to the terminal connection portion 50b and the tip portion of the connection portion 70b in a state in which the tip portion of the connection portion 70b is in contact with the terminal connection portion 50b in a region a predetermined distance below the upper end of the terminal connection portion 50b. Thus, a part of the melted terminal connection portion 50b and the melted connection portion 70b are fused together, thereby forming the welding portion 80 having a sufficient thickness. As a result, such an arrangement is capable of suppressing an increase in the resistance between the terminal connection portion 50b and the connecting member 70, and suppressing degradation of the connection strength between the terminal connection portion 50b and the connecting member 70.

### [Modification 1]

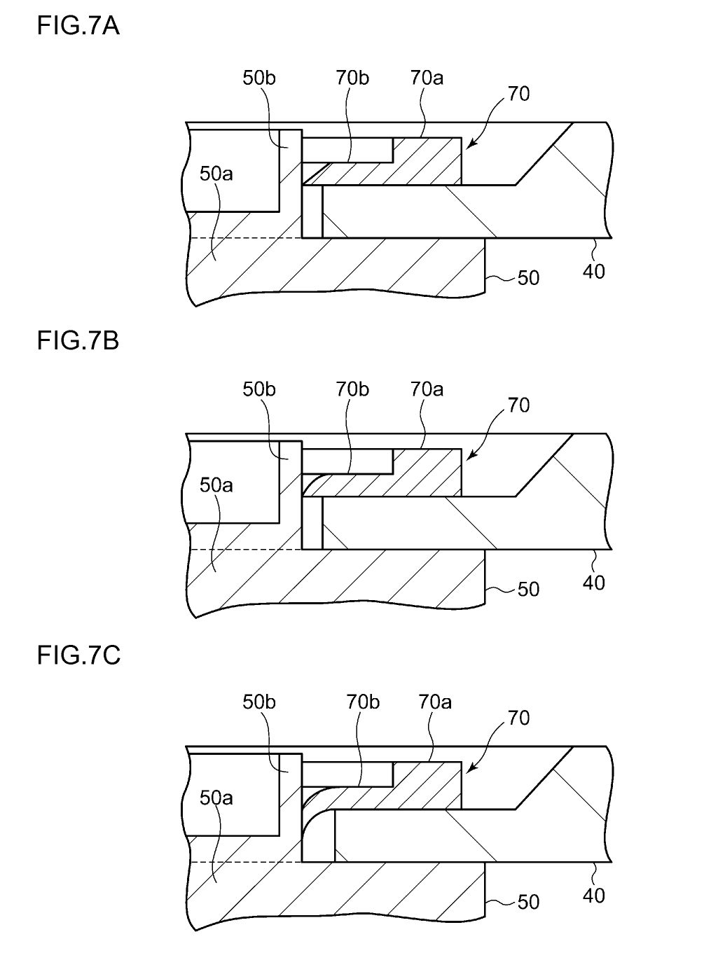

FIG. 7A is an enlarged cross-sectional diagram showing a schematic configuration in the vicinity of a connection portion between the external terminal and the bus bar included in the assembled battery according to a modification 1. As shown in FIG. 7A, with the assembled battery 10 according to the modification 1, in the vicinity of a contact region where the terminal connection portion 50b and the tip portion of the connection portion 70b are in contact with each other, the thickness of the connection portion 70b becomes greater as the distance increases from the contact region. It should be noted that the connecting member 70 is configured to have a flat bottom face, and to have the connection portion 70b with its tip portion positioned on the side of the bottom face of the connecting member 70.

With such an arrangement, the tip portion of the connection portion 70b is positioned relatively below the terminal connection portion 50b. Thus, such an arrangement allows the tip portion of the connection portion 70b to be arranged in contact with the terminal connection portion 50b in a region a predetermined distance below the upper end of the terminal connection portion 50b in a surer manner. As a result, by emitting the laser beam to the contact region, such an arrangement allows the tip portion of the connection portion 70b to be melted with high efficiency. Thus, such an arrangement provides a bonding portion that connects the terminal connection portion 50b and the connection portion 70b with a sufficient thickness.

Furthermore, with such an arrangement, the thickness of the connection portion 70b becomes greater as the distance increases from the contact portion (bonding portion) that connects the terminal connection portion 50b and the connection portion 70b. Thus, such an arrangement is capable of effectively suppressing an increase in the resistance between the terminal connection portion 50b and the connecting member 70.

### [Modification 2]

FIG. 7B is an enlarged cross-sectional diagram showing a schematic configuration before welding in the vicinity of a connection portion that connects the external terminal and the bus bar included in the assembled battery according to a modification 2. As shown in FIG. 7B, with the assembled battery 10 according to the modification 2, in the vicinity of a contact portion where the terminal connection portion 50b and the tip portion of the connection portion 70b are in contact, the thickness of the connection portion 70b becomes greater as the distance increases from the contact portion. Furthermore, the connection portion 70b is configured to have a rounded upper face. It should be noted that the connecting member 70 is configured to have a flat bottom face, and to have the connection portion 70b with its tip portion positioned on the side of the bottom face of the connecting member 70.

Such an arrangement provides an increased surface area of the connection portion 70b, in addition to the advantage of the modification 1. This increases the area of the welding portion, thereby providing improved connection strength between the terminal connection portion 50b and the connecting member 70.

### [Modification 3]

FIG. 7C is an enlarged cross-sectional diagram showing a schematic configuration before welding in the vicinity of a connection portion that connects the external terminal and the bus bar included in the assembled battery according to a modification 3. As shown in FIG. 7C, with the assembled battery 10 according to the modification 3, the connection portion 70b is configured such that its upper face is formed as a convex rounded face and its lower face is also formed as a rounded face that approximately parallels the shape of the upper face of the connection portion 70b. Furthermore, the connection portion 70b is configured such that its tip has a face which allows it to be closely matched to the terminal connection portion 50b.

Such an arrangement provides an increased contact area where the connection portion 70b is in contact with the terminal connection portion 50b. Thus, such an arrangement allows heat to be easily released from the terminal connection portion 50b to the connection portion 70b in the laser emission operation. As a result, such an arrangement is capable of protecting the terminal connection portion 50b from excessive melting.

### Embodiment 2

An assembled battery 10 according to an embodiment 2 has a configuration in which the external terminals are directly welded to the bus bar 40. Description will be made below regarding the present embodiment. It should be noted that the main configurations of the assembled battery 10 and the cell 30 are basically the same as those in the embodiment 1. The same components as those in the embodiment 1 are denoted by the same reference symbols, and description thereof will be omitted as appropriate.

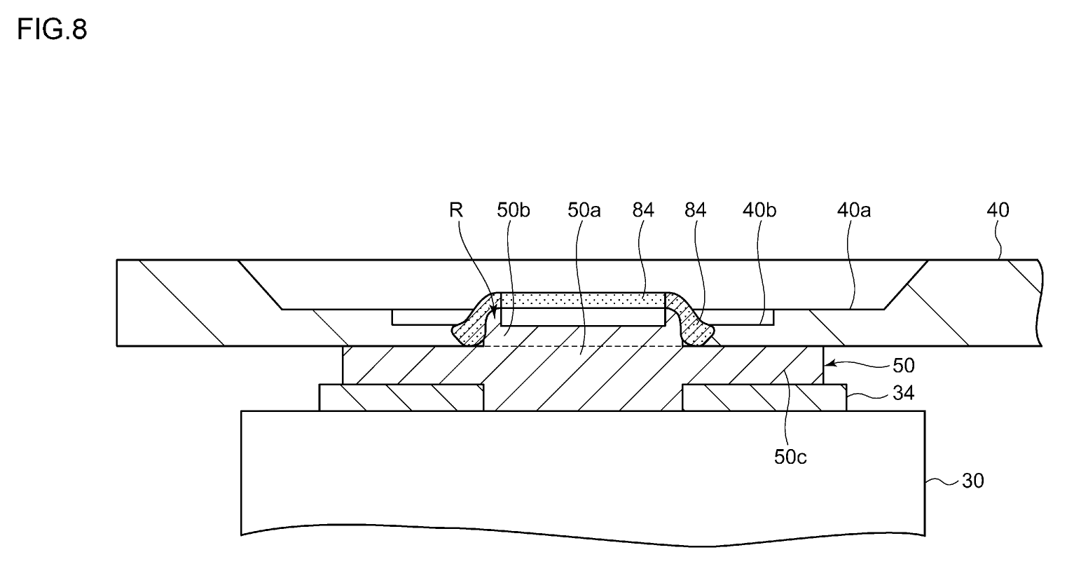

FIG. 8 is an enlarged cross-sectional diagram showing a schematic configuration in the vicinity of a connection portion that connects the external terminal and the bus bar included in the assembled battery according to the embodiment 2. It should be noted that FIG. 8 shows the negative electrode terminal 50 as an example of the external terminal.

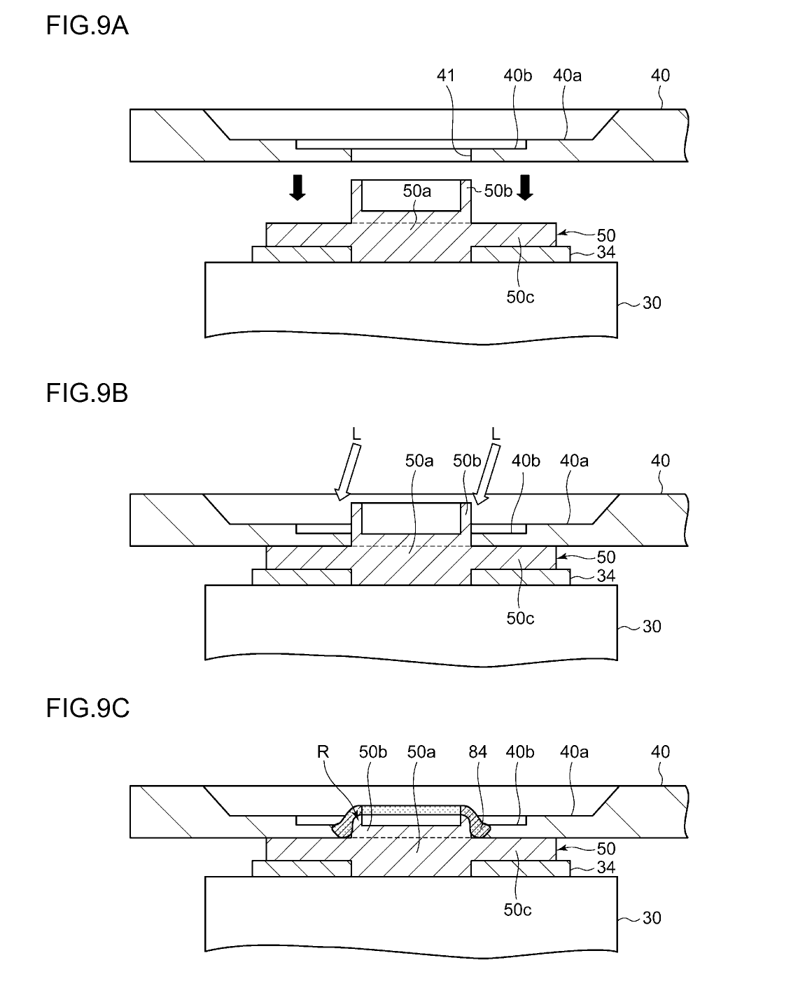

As shown in FIG. 8, with the assembled battery 10 according to the present embodiment, the bus bar 40 includes a base portion 40a and a connection portion 40b configured to have a thickness that is smaller than that of the base portion 40a and such that it protrudes from the base portion 40a toward the through hole 41. The base portion 40a and the connection portion 40b are monolithically formed in the form of a single unit. The connection portion 40b is configured such that it extends over the entire circumference of the through hole 41 (see FIG. 9A) formed in the bus bar 40. The base portion 40a has a thickness of approximately 0.1 mm to 5 mm, for example. The connection portion 40b has a thickness of approximately 0.05 mm to 2.5 mm. Furthermore, the connection portion 40b is configured to have a protrusion length, i.e., a length from its tip to the base portion 40a, that is greater than the diameter of the laser beam to be emitted in the welding.

The negative electrode terminal 50 is inserted into the through hole 41 formed in the bus bar 40. The bus bar 40 is arranged such that its lower face is in contact with the upper face of the flange portion 50c of the negative electrode terminal 50. The negative electrode terminal 50 is configured such that its terminal connection portion 50b protrudes upward from the opening of the through hole 41 on the side that is opposite to the outer package 31. The tip portion of the connection portion 40b of the bus bar 40 and the terminal connection portion 50b are connected by means of a welding portion 84 in a region a predetermined distance below the upper end of the terminal connection portion 50b. In other words, the terminal connection portion 50b has a region (the region indicated by the arrow R in FIG. 8) that is distant from the outer package 31 as compared with a portion of the connection portion 40b that is adjacent to the welding portion 84.

### [Cell Connection Method]

Next, description will be made regarding a cell connection method according to the embodiment 2 with reference to FIGS. 9A through 9C. FIGS. 9A through 9C are cross-sectional process diagrams each showing the cell connection method according to the embodiment 2. It should be noted that FIGS. 9A through 9C each show the negative electrode terminal 50 as an example of the external terminal.

First, as shown in FIG. 9A, the bus bar 40 is prepared, comprising the base portion 40a and the connection portion 40b configured to have a thickness that is smaller than that of the base portion 40a and such that it protrudes from the base portion 40a toward the through hole 41. Furthermore, the cell 30 is prepared. Next, after the negative electrode terminal 50 and the through hole 41 of the bus bar 40 are aligned, the bus bar 40 is mounted on the negative electrode terminal 50.

As shown in FIG. 9B, after the bus bar 40 is mounted on the negative electrode terminal 50, the tip portion of the connection portion 40b is in contact with the terminal connection portion 50b in a region a predetermined distance below the upper end of the terminal connection portion 50b. In this state, the laser L is emitted to the tip portion of the connection portion 40b so as to melt the tip portion of the connection portion 40b and a part of the terminal connection portion 50b, thereby welding the connection portion 40b and the terminal connection portion 50b. The laser L is emitted over the entire circumference of the portion where the tip portion of the connection portion 40b is in contact with the terminal connection portion 50b. It should be noted that the region to be irradiated by the laser L is not restricted to such a region. Also, the laser L may be emitted to only a part of such a portion where the tip portion of the connection portion 40b is in contact with the terminal connection portion 50b, as long as such an arrangement provides sufficient connection strength.

By means of such emission of the laser L described above, as shown in FIG. 9C, the welding portion 84 is formed between the remaining portion of the connection portion 40b and the terminal connection portion 50b, thereby connecting the bus bar 40 and the negative electrode terminal 50. In this stage, a part of the terminal connection portion 50b is not welded and remains as a region R that is at a distance from the cell 30 as compared with a portion of the connection portion 40b that is adjacent to the welding portion 84.

As described above, with the assembled battery 10 according to the present embodiment, the laser L is emitted to the terminal connection portion 50b and the tip portion of the connection portion 40b in a state in which the tip portion of the connection portion 40b is in contact with the terminal connection portion 50b in a region a predetermined distance below the upper end of the terminal connection portion 50b. Such an arrangement is capable of melting the tip portion of the connection portion 40b with high efficiency so as to fuse together a part of the terminal connection portion 50b thus melted and the connection portion 40b thus melted, thereby configuring the welding portion 84 to have a sufficient thickness. Thus, such an arrangement suppresses an increase in the resistance between the terminal connection portion 50b and the bus bar 40, and suppresses degradation of the connection strength between the terminal connection portion 50b and the bus bar 40.

Also, the configuration of the connection portion 70b according to any one of the aforementioned modifications 1 through 3 may be applied to the configuration of the connection portion 40b. Also, the contact arrangement according to any one of the aforementioned modifications 1 through 3, configured to arrange the connection portion 70b and the terminal connection portion 50b such that they are in contact, may be applied to the contact arrangement configured to arrange the connection portion 40b and the terminal connection portion 50b such that they are in contact.

This allows an arrangement in which the connection portion 40b and the terminal connection portion 50b are welded to have the same advantages as described in the modifications 1 through 3.

The present invention is by no means intended to be restricted to the aforementioned embodiments. Also, various kinds of modifications such as design modifications may be made based on the knowledge of those skilled in this art, which are also encompassed within the technical scope of the present invention.

### DESCRIPTION OF THE REFERENCE NUMERALS

10 assembled battery, 30 cell, 40 bus bar, 40a base portion, 40b connection portion, 50 negative electrode terminal, 50a base portion, 50b terminal connection portion, 60 positive electrode terminal, 60a base portion, 60b terminal connection portion, 70 connecting member, 70a base portion, 70b connection portion, 80, 82, 84 welding portion.

### INDUSTRIAL APPLICABILITY

The present invention is applicable to an assembled battery comprising multiple cells connected to each other.

1. An assembled battery comprising:
a plurality of cells each comprising an electrode body, a casing configured to house the electrode body, and external terminals each of which is configured as an exterior component of the casing and each of which is electrically connected to the electrode body;
an electrical connection member configured to have a through hole which allows the external terminal to pass through it, and to electrically connect the external terminal of one of two adjacent cells and the external terminal of the other of these two adjacent cells;
an electrically conductive connecting member configured to fixedly connect a terminal connection portion of the external terminal, which is a tip region passing through the through hole, and the electrical connection member arranged so as to surround the terminal connection portion; and
a welding portion configured to connect the terminal connection portion and the connecting member,
wherein the terminal connection portion has a region that is at a distance from the casing as compared with a portion of the connecting member that is adjacent to the welding portion.

2. The assembled battery according to claim 1, wherein the connecting member is configured such that, in the vicinity of the welding portion, its thickness becomes greater as the distance increases from the welding portion.

3. An assembled battery comprising:
a plurality of cells each comprising an electrode body, a casing configured to house the electrode body, and external terminals each of which is configured as an exterior component of the casing and each of which is electrically connected to the electrode body;
an electrical connection member configured to have a through hole which allows the external terminal to pass through it, and to electrically connect the external terminal of one of two adjacent cells and the external terminal of the other of these two adjacent cells; and
a welding portion configured to connect a terminal connection portion of the external terminal, which is a tip region passing through the through hole, and the electrical connection member arranged so as to surround the terminal connection portion,
wherein the terminal connection portion has a region that is at a distance from the casing as compared with a portion of the electrical connection member that is adjacent to the welding portion.

4. The assembled battery according to claim 3, wherein the electrical connection member is configured such that, in the vicinity of the welding portion, its thickness becomes greater as the distance increases from the welding portion.

5. A cell connection method for connecting an external terminal of a cell to an electrical connection member configured to electrically connect the external terminal of one of two adjacent cells and the external terminal of the other of these two adjacent cells, the cell connection method comprising:
preparing an electrical connection member having a through hole which allows the external terminal to pass through it;
inserting a tip portion of the external terminal into the through hole such that the tip portion passes through the through hole;
arranging an electrically conductive connecting member such that it is in contact with a face of the electrical connection member in a region a predetermined distance below an upper end of the tip portion on a side that is opposite to the cell; and welding a contact portion at which the tip portion and the connecting member are in contact.

6. The cell connection method according to claim 5, wherein the connecting member is configured such that, in the vicinity of the contact portion at which the electrical connection member and the tip portion are in contact, its thickness becomes greater as the distance increases from the contact portion.

7. A cell connection method for connecting an external terminal of a cell to an electrical connection member configured to electrically connect the external terminal of one of two adjacent cells and the external terminal of the other of these two adjacent cells, the cell connection method comprising:
preparing an electrical connection member having a through hole which allows the external terminal to pass through it;
inserting a tip portion of the external terminal into the through hole such that the tip portion passes through the through hole;
arranging the electrical connection member such that it is in contact with a region a predetermined distance below an upper end of the tip portion; and
welding a contact portion at which the tip portion is in contact with the electrical connection member.

8. The cell connection method according to claim 7, wherein the electrical connection member is configured such that, in the vicinity of the contact portion at which the electrical connection member and the tip portion are in contact, its thickness becomes greater as the distance increases from the welding portion.
